(19) United States
(12) Patent Application Publication
(10) Pub. No.: US 2016/0161689 A1
(43) Pub. Date: Jun. 9, 2016

(54) CONNECTOR HOLDER

(71) Applicant: FUJIKURA LTD., Tokyo (JP)

(72) Inventor: Akito NISHIMURA, Sakura-shi (JP)

(73) Assignee: FUJIKURA LTD., Tokyo (JP)

(21) Appl. No.: 14/956,627

(22) Filed: Dec. 2, 2015

(30) Foreign Application Priority Data
Dec. 4, 2014 (JP) 2014-246206

(51) Int. Cl. G02B 6/42; G02B 6/30

(52) U.S. Cl. CPC G02B 6/4292; G02B 6/30; G02B 6/423

(57) ABSTRACT

Disclosed is a connector holder including: a base body part; a pair of side wall parts that projects from the base body part; and a connector housing part that is formed by the base body part and the pair of side wall parts, and that is for housing an optical connector body which holds an end section of an optical fiber. A recess is formed in an inner surface of each of the side wall parts, the recesses being formed so as to oppose one another. A gap is formed between a side surface of the optical connector body and each recess when the optical connector body is housed in the connector housing part.

### TECHNICAL FIELD

The present invention relates to a connector holder.

### BACKGROUND ART

Connector holders (also called receptacles) are known that detachably fix, to a circuit board, an optical connector body that holds an end section of an optical fiber. For example, Patent Literature 1 describes a technique wherein: a circuit board is provided with a module including a photoelectric conversion element; and, by fitting a positioning pin (or positioning hole) of a connector holder together with a positioning hole (or positioning pin) of an optical connector body and fixing the optical connector body to the connector holder, an optical fiber on the optical connector body side and the photoelectric conversion element are optically connected together.

Optical signal loss increases when there is misalignment in the positional relationship between a connector holder and an optical connector body. Thus, the optical connector body needs to be accurately fixed with respect to the connector holder. For example, misalignment in the positional relationship between a connector holder and an optical connector body can be suppressed by matching the shape of the connector holder's housing part for housing an optical connector body with the external profile of the optical connector body. Also, side walls of the housing part guide the optical connector body during housing in the connector holder, and facilitate housing of the optical connector body in the connector holder.

However, in such cases, it becomes difficult to insert a tool or the like between the connector holder and the optical connector body when removing the optical connector body from the connector holder, making it difficult to remove the optical connector body.

An objective of the present invention is to facilitate removal of an optical connector body.

### CITATION LIST

### Patent Literature

Patent Literature 1: JP 2000-292658 A

### SUMMARY OF INVENTION

A primary aspect of the invention is a connector holder including: a base body part; a pair of side wall parts that projects from the base body part; and a connector housing part that is formed by the base body part and the pair of side wall parts, and that is for housing an optical connector body which holds an end section of an optical fiber. A recess is formed in an inner surface of each of the side wall parts, the recesses being formed so as to oppose one another. A gap is formed between a side surface of the optical connector body and each recess when the optical connector body is housed in the connector housing part.

Other features of the present invention are made clear by the Specification and Drawings below.

With the present invention, removal of an optical connector body can be facilitated.

### BRIEF DESCRIPTION OF DRAWINGS

FIGS. 1A and 1B are overall perspective views of an optical connector device 1, wherein FIG. 1A is a perspective view as seen from diagonally above, and FIG. 1B is a perspective view as seen from diagonally below.

FIG. 2A is a diagram in which a tool 40 has been inserted in the state of FIG. 1A, and FIG. 2B is an exploded perspective view of the optical connector device 1.

FIG. 3 is an overall cross-section of the optical connector device 1.

FIGS. 4A to 4C are views from above of a connector holder 20, wherein FIG. 4A is a diagram of the connector holder 20 alone, FIG. 4B is a diagram of a state in which an optical path conversion connector 10 is housed in a connector housing part 24 of the connector holder 20, and FIG. 4C is a diagram of a state in which a lid 26 of the connector holder 20 is closed.

FIGS. 5A to 5C are explanatory diagrams of a connector holder 20 of a second embodiment, wherein FIG. 5A is a cross-section when a connector housing part 24 is empty, FIG. 5B is a cross-section when an optical path conversion connector 10 is housed in the connector housing part 24, and FIG. 5C is a cross-section when a tool 40 has been inserted.

### DESCRIPTION OF PREFERRED EMBODIMENTS

At least the following matters are made clear from the Specification and Drawings described below.

Disclosed is a connector holder including: a base body part; a pair of side wall parts that projects from the base body part; and a connector housing part that is formed by the base body part and the pair of side wall parts, and that is for housing an optical connector body which holds an end section of an optical fiber. A recess is formed in an inner surface of each of the side wall parts, the recesses being formed so as to oppose one another. A gap is formed between a side surface of the optical connector body and each recess when the optical connector body is housed in the connector housing part.

This connector holder enables easy removal of the optical connector body because a tool or the like can be easily inserted into the gaps between the side surfaces of the optical connector body and the respective recesses.

It is preferable that a tapered surface is formed to each recess. This thereby enables the leading ends of the tool to be guided along the respective tapered surfaces to a position at a lower portion of the optical connector body, and thus, the optical connector body can be removed easily.

It is preferable that: the connector holder further includes a lid that sandwiches, between itself and the base body part, the optical connector body housed in the connector housing part; and the lid includes a pressing section that presses the optical connector body toward the base body part. This thereby enables the optical connector body to be reliably fixed to the connector holder.

It is preferable that the lid includes an engagement section that engages with a body-side engagement section provided to each of the side wall parts. This thereby enables the optical connector body to be maintained in a state sandwiched between the base body part and the lid.

### First Embodiment

{Overall Configuration}

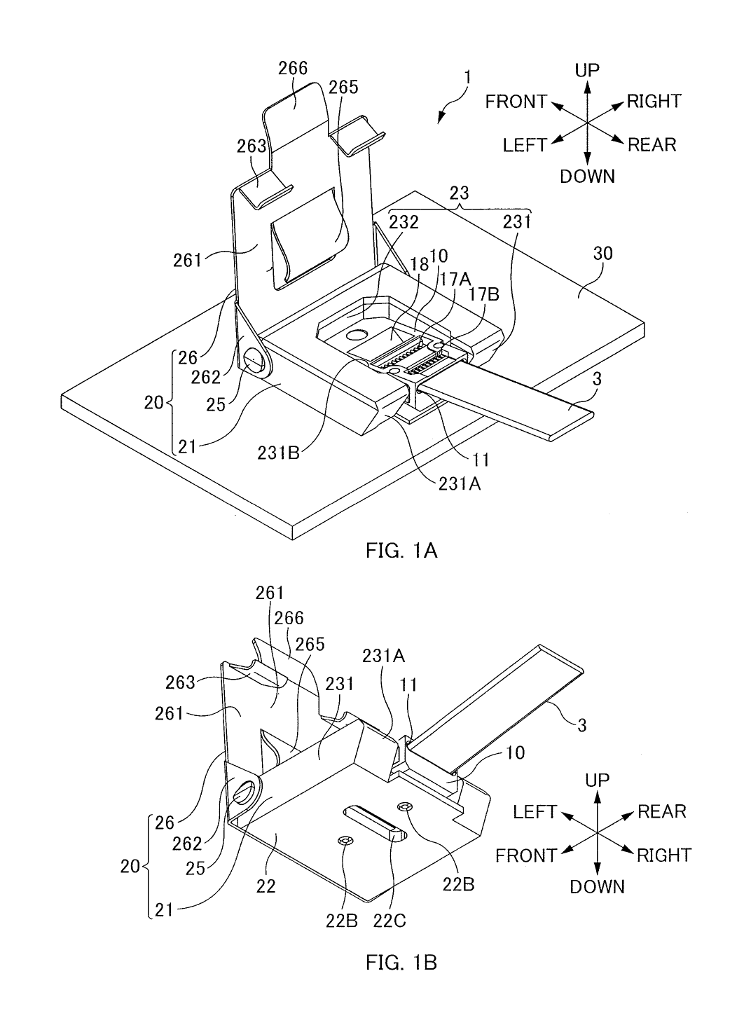

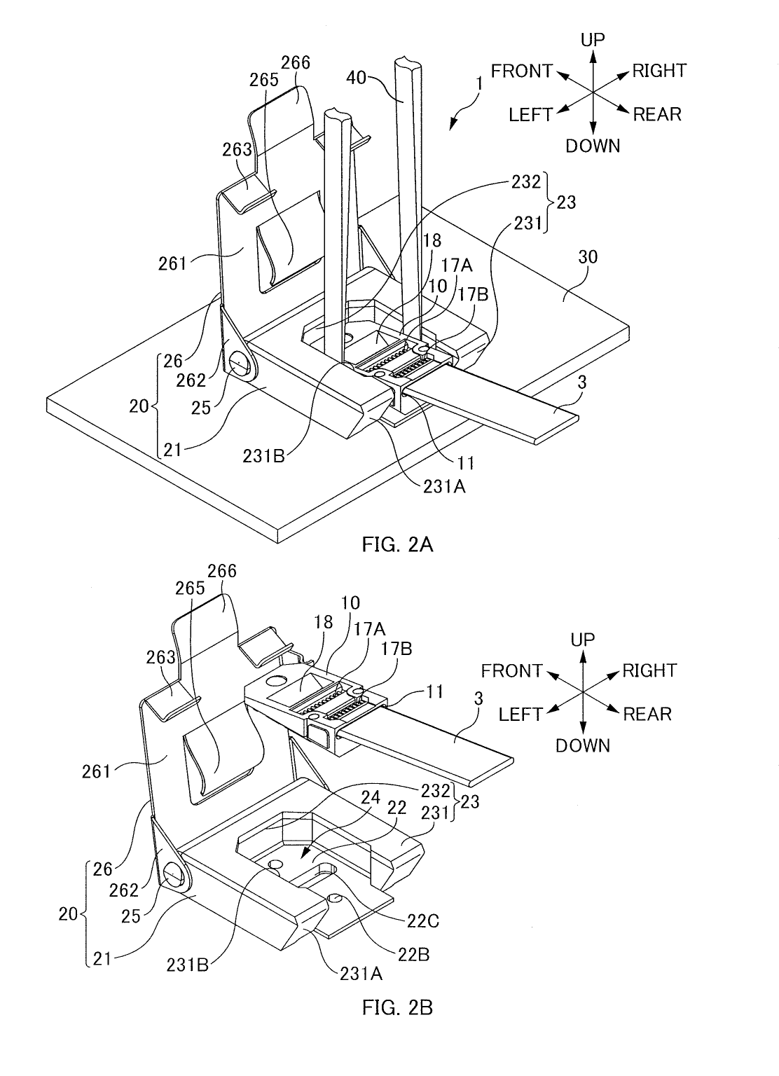

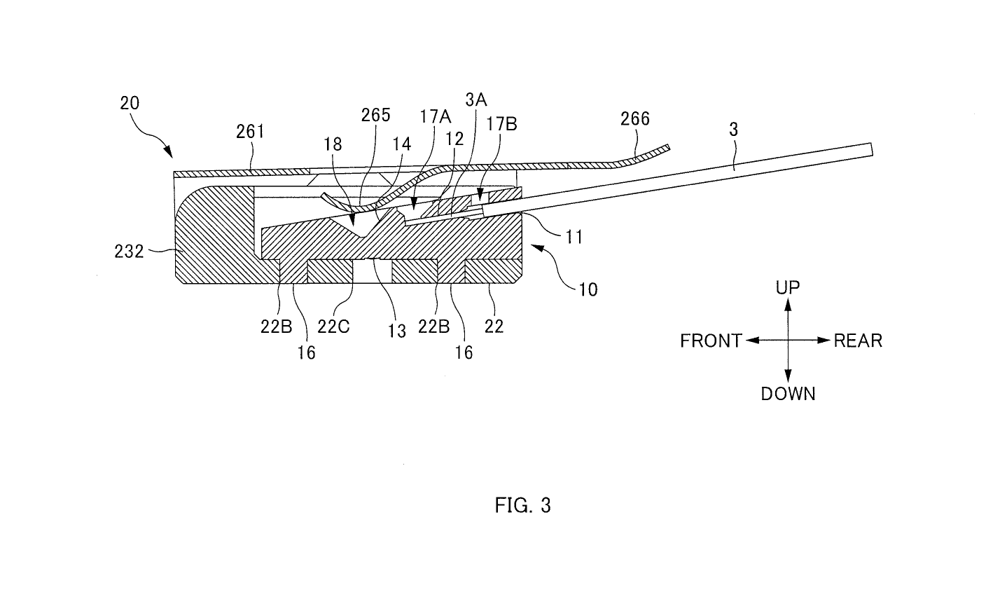

FIGS. 1A and 1B are overall perspective views of an optical connector device 1. FIG. 1A is a perspective view as seen from diagonally above, and FIG. 1B is a perspective view as seen from diagonally below. FIG. 2A is a diagram in which a tool 40 has been inserted in the state of FIG. 1A, and FIG. 2B is an exploded perspective view of the optical connector device 1. FIG. 3 is an overall cross-section of the optical connector device 1. It should be noted that a circuit board 30 is omitted from illustration in FIG. 1B, FIG. 2B, and FIG. 3.

In the following explanation, each direction is defined as illustrated in the drawings. Namely, the “up-and-down direction” is a direction (light incident and emitting direction) perpendicular to an optical signal surface 13 (see FIG. 3) of an optical path conversion connector 10, with “up” as the side toward a reflection surface 14 as viewed from the optical signal surface 13 of the optical path conversion connector 10, and “down” as the opposite side thereto (the circuit board 30 side). The “front-to-rear direction” is the direction in which two positioning pins 16 of the optical path conversion connector 10 are aligned, with the “rear” as the side toward which an optical fiber tape 3 extends from the optical path conversion connector 10, and the “front” as the opposite side thereto. The “left-to-right direction” is a direction perpendicular to the up-and-down direction and to the front-to-rear direction. It should be noted that the left-to-right direction is sometimes referred to as the “width direction”.

The optical connector device 1 of the present embodiment includes an optical path conversion connector 10 (corresponding to an optical connector body) and a connector holder 20. Note that the connector holder 20 is fixed to a circuit board 30 on which a photoelectric conversion module (not illustrated) is mounted. The photoelectric conversion module includes a photoelectric conversion element (not illustrated) that converts between electrical signals and optical signals, and is a module that converts between electrical signals and optical signals. Examples of photoelectric conversion elements include light emitting elements that convert electrical signals into optical signals (for example, a surface emitting laser (vertical cavity surface emitting laser (VCSEL)), light receiving elements that convert optical signals into electrical signals (for example, photodiodes), and the like. The photoelectric conversion module may include a drive circuit that drives the photoelectric conversion element, and an optical element, such as a lens array.

By positionally aligning the optical path conversion connector 10 and the connector holder 20, the optical connector device 1 optically connects the photoelectric conversion element of the circuit board 30 and the optical fiber tape 3 (optical fibers 3A) together passively.

{Optical Path Conversion Connector 10}

The optical path conversion connector 10 is a member that holds an end section of an optical fiber tape 3 (optical fibers 3A) for transmitting optical signals. The optical path conversion connector 10 includes an optical fiber insertion opening 11, a plurality of optical fiber holes 12, an optical signal surface 13, a reflection surface 14, and positioning pins 16. The optical path conversion connector 10 is formed from a transparent resin through which optical signals are able to pass. The optical signals that are incident on, or emitted from, the respective end surfaces of the optical fibers 3A are refracted at the reflection surface 14, and are incident on, or emitted from, the optical signal surface 13. Stated differently, the respective optical paths of the optical signals are converted inside the optical path conversion connector 10 by the reflection surface 14.

The optical fiber insertion opening 11 is an insertion opening through which the optical fibers 3A (the optical fiber tape 3) are inserted into the optical path conversion connector 10. The optical fiber insertion opening 11 opens onto the rear end surface of the optical path conversion connector 10.

The optical fiber holes 12 are holes for inserting respective end sections of the optical fibers 3A. A naked fiber, in which a covering has been removed from an optical fiber core, is inserted into each optical fiber hole 12. The optical fiber holes 12 penetrate between a first adhesive-filled section 17A and a second adhesive-filled section 17B (see FIG. 3). The optical fibers 3A are positioned with respect to the optical path conversion connector 10 by inserting the optical fibers 3A into the respective optical fiber holes 12 until the respective end surfaces of the optical fibers 3A abut against the front surface of the first adhesive-filled section 17A. The plurality of optical fiber holes 12 are formed in a row along the left-to-right direction (width direction).

It should be noted that the first adhesive-filled section 17A and the second adhesive-filled section 17B are cavities that are filled with an adhesive. The first adhesive-filled section 17A is a cavity for applying an adhesive to the respective end sections of the optical fibers 3A that project from the optical fiber holes 12. The second adhesive-filled section 17B is a cavity for applying an adhesive to the optical fiber tape 3 further to the rear side than the optical fiber holes 12.

The optical signal surface 13 is a surface where optical signals are incident on, or emitted from, and is formed at the lower surface of the optical path conversion connector 10. A plurality of optical signals are incident on, or emitted from, the optical signal surface 13. The optical signal surface 13 of the optical path conversion connector 10 opposes an opening 22C in the connector holder 20 when the optical path conversion connector 10 and the connector holder 20 are positionally aligned. The optical signal surface 13 is formed parallel to the left-to-right direction (width direction). The optical signal surface 13 is disposed between the two positioning pins 16 in the front-to-rear direction. A plurality of lenses are disposed on the optical signal surface 13 in a row along the left-to-right direction. Each of the lenses of the optical signal surface 13 is disposed on the optical axis of the respective optical signal. It should be noted that for the optical signal surface 13, a flat surface may be employed, with no lenses disposed on the optical signal surface 13.

The reflection surface 14 is a surface that reflects optical signals. A recess 18 is formed in the upper surface of the optical path conversion connector 10, and the sloping surface on the rear side of the recess 18 constitutes the reflection surface 14. The reflection surface 14 is the boundary plane between the transparent resin configuring the optical path conversion connector 10 and external air, and light is reflected at the boundary plane between the two due to the difference in refractive index between the two. The reflection surface 14 is formed parallel to the left-to-right direction (width direction). The reflection surface 14 is positioned on the upper side of the optical signal surface 13, and is disposed between the two positioning pins 16 in the front-to-rear direction. A plurality of lenses (light-concentrating curved surfaces) are disposed on the reflection surface 14 in a row along the left-to-right direction. It should be noted that, for the reflection surface 14, a flat surface may be employed, with no lenses disposed on the reflection surface 14.

The optical signals that pass through the optical path conversion connector 10 are reflected at the reflection surface 14. When optical signals are emitted from the respective end surfaces of the optical fibers 3A, the optical signals are reflected at the reflection surface 14, and are emitted from the optical signal surface 13 toward the outside. On the contrary, when the optical signals are incident on the optical signal surface 13 from the outside, the optical signals are reflected by the reflection surface 14, and are incident on the respective end surfaces of the optical fibers 3A.

The positioning pins 16 are pins for inserting into respective positioning holes 221 of the connector holder 20. The optical path conversion connector 10 and the connector holder 20 are positionally aligned by inserting the positioning pins 16 of the optical path conversion connector 10 into the respective positioning holes 221 of the connector holder 20. The positioning pins 16 project from the lower surface of the optical path conversion connector 10. The two positioning pins 16 are parallel to the up-and-down direction (the direction perpendicular to the optical signal surface 13), and are formed in a row along the front-to-rear direction.

{Connector Holder 20}

The connector holder 20 is a member that fixes the optical path conversion connector 10. The connector holder 20 is also sometimes referred to as a receptacle. The connector holder 20 is fixed to the circuit board 30 by an adhesive or the like. It should be noted that in the present embodiment, the optical conversion module is mounted on the lower surface side of the circuit board 30. An opening (not illustrated) is also formed in the circuit board 30 at a site opposing the opening 22C of the connector holder 20 (described later). This thereby enables the optical fiber tape 3 (the optical fibers 3A) of the optical path conversion connector 10 and the photoelectric conversion element of the optical conversion module to be optically connected through the opening 22C of the connector holder 20 and through the opening of the circuit board 30.

The connector holder 20 includes a holder body 21, and a lid 26. The holder body 21 is a resin molded component, and the lid 26 is a metal component. However, the holder body 21 and the lid 26 may be configured as an integrally molded resin component coupled by a thinned hinge section.

{Holder Body 21}

The holder body 21 is apart for housing the optical path conversion connector 10. The lower surface of the holder body 21 is a fixing surface (attachment surface) for fixing to the circuit board 30. A connector housing part 24 for housing the optical path conversion connector 10 is formed in an upper surface of the holder body 21 (see FIG. 2). The holder body 21 includes a base body part 22 and a wall part 23. The connector housing part 24 is formed by the base body part 22 and the wall part 23.

The base body part 22 is a part configuring the holder body 21, and is a part having a plate shape perpendicular to the up-and-down direction. The lower surface of the base body part 22 is a fixing surface (attachment surface) for fixing to the circuit board 30. The upper surface of the base body part 22 opposes the lower surface of the optical path conversion connector 10. The base body part 22 is apart that sandwiches the optical path conversion connector 10 from above and below, between itself and the lid 26. Positioning holes 22B and the aforementioned opening 22C are formed in the base body part 22.

The positioning holes 22B are positioning holes into which the respective positioning pins 16 of the optical path conversion connector 10 are fitted. Passive positional alignment between the optical path conversion connector 10 and the connector holder 20 is performed by the positioning pins 16 of the optical path conversion connector 10 being inserted into the respective positioning holes 22B of the connector holder 20. The positioning holes 22B are through holes parallel to the up-and-down direction, and two positioning holes 22B are formed in a row along the front-to-rear direction. More specifically, the two positioning holes 22B are formed in a row along the front-to-rear direction so as to sandwich the opening 22C.

The opening 22C allows incident or emitted optical signals to pass through between the photoelectric conversion module mounted to the circuit board 30 and the optical path conversion connector 10, and the opening 22C is formed so as to penetrate through the base body part 22 between the two positioning holes 22B. Namely, the optical signal surface 13 that is on the lower surface of the optical path conversion connector 10 is arranged in opposition to the photoelectric conversion element of the circuit board 30 across the opening 22C.

The wall part 23 is a part having a wall shape projecting upward from the base body part 22. The wall part 23 includes a pair of side wall parts 231 and a front wall part 232.

The side wall parts 231 are parts having wall shapes projecting upward from the respective left and right edges of the base body part 22. The pair of side wall parts 231 is formed so as to oppose one another in the left-to-right direction.

An anchor section 231A and a wider-width recess 231B are formed in each of the side wall parts 231.

The anchor section 231A (corresponding to a body-side engagement section) is formed on the rear side of each side wall part 231. The anchor sections 231A are parts where respective engagement sections 263 of the lid 26 latch onto. The holder body 21 and the lid 26 adopt an engaged state by engaging the engagement sections 263 of the lid 26 with the respective anchor sections 231A.

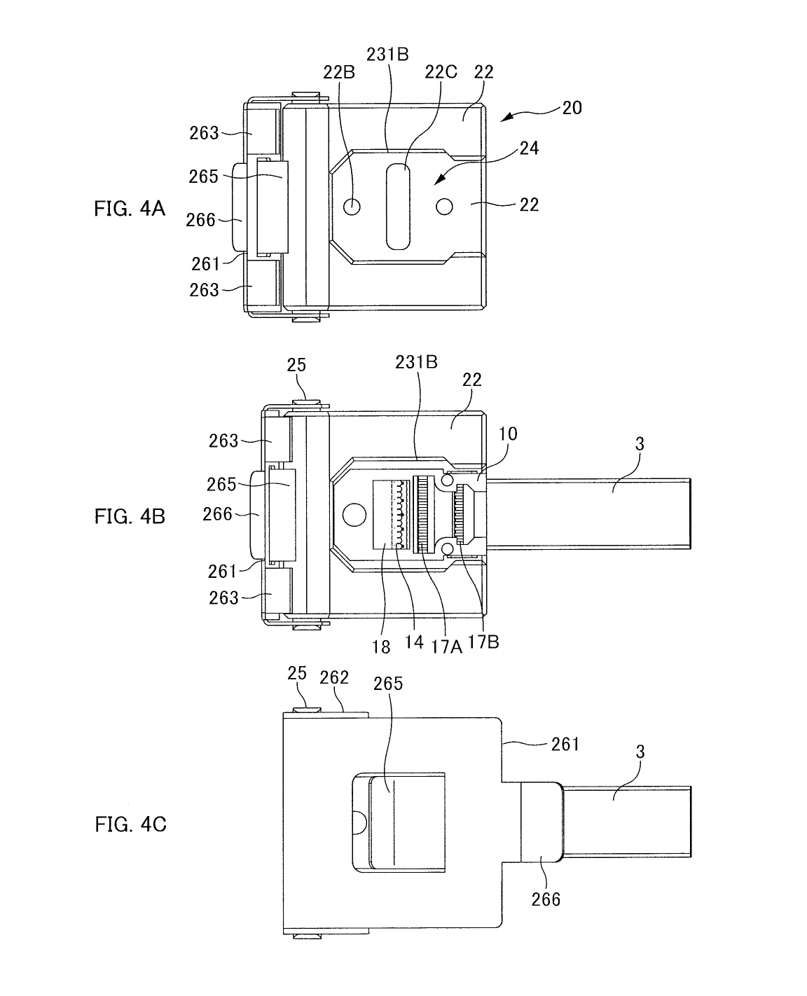

The wider-width recess 231B (corresponding to a recess of the connector holder) is formed in the inner wall surface of each of the side wall parts 231. The distance between the opposing wider-width recesses 231B is greater than the maximum width of the optical path conversion connector 10. Thus, a gap is formed between a side surface of the optical path conversion connector 10 and each wider-width recess 231B of the connector holder 20 when the optical path conversion connector 10 is housed in the connector housing part 24 (see FIG. 4B).

The front-to-rear direction length of each wider-width recess 231B is shorter than the front-to-rear direction length of the optical path conversion connector 10. Other than at the wider-width recesses 231B, the distance (the internal dimension in the left-to-right direction) between the inner wall surfaces of the respective side wall parts 231 is equivalent to the width of the optical path conversion connector 10. Thus, the optical path conversion connector 10 can be housed by being inserted in between the pair of side wall parts 231 (see FIG. 4B). The optical path conversion connector 10 is positionally aligned in the width direction with respect to the connector holder 20 by housing the optical path conversion connector 10 between the pair of side wall parts 231. Thus, the pair of side wall parts 231 has the function of positionally aligning the optical path conversion connector 10 in the width direction.

The front wall part 232 is a part having a wall shape that projects upward from the front edge of the base body part 22. The positioning pins 16 of the optical path conversion connector 10 are readily aligned with the positions of the positioning holes 22B of the connector holder 20 by causing the front end surface of the optical path conversion connector 10 to contact the front wall part 232. This thereby facilitates housing of the optical path conversion connector 10 in the connector housing part 24 of the connector holder 20.

A rotation shaft 25 is formed at each of the two left-to-right direction edges of the front wall part 232. The rotation shafts 25 are shafts that rotatably support the lid 26, and are parts that form the center of rotation of the lid 26.

{Lid 26}

The lid 26 is a member for fixing the optical path conversion connector 10 housed in the holder body 21. The optical path conversion connector 10 is fixed to the connector holder 20 by closing the lid 26 in a state in which the optical path conversion connector 10 is housed in the holder body 21. Removal of the optical path conversion connector 10 from the connector holder 20 is enabled by opening the lid 26.

The lid 26 includes a lid body section 261, shaft bearings 262, the aforementioned engagement sections 263, a pressing section 265, and an operation section 266.

The shaft bearings 262 are sites that rotatably support the lid body section 261 with respect to the respective rotation shafts 25 of the holder body 21.

The engagement sections 263 are parts that latch onto the respective anchor sections 231A of the side wall parts 231 of the holder body 21 in order to retain the lid 26 in a closed state. A pair of the engagement sections 263 is provided to the rear side of the lid body section 261 at positions on either side of the operation section 266. It should be noted that the front-to-rear direction length of the connector holder 20 can be shortened due to disposing the engagement sections 263 in the respective side sections of the lid body section 261.

The pressing section 265 is a part that presses the optical path conversion connector 10 toward the holder body 21. When viewed along the left-to-right direction, the pressing section 265 is formed so as to project from the lid body section 261 toward the holder body 21 side. When the lid 26 is closed in a state in which the optical path conversion connector 10 is housed inside the holder body 21, the pressing section 265 contacts the optical path conversion connector 10 in an elastically deformed state, and presses the optical path conversion connector 10 toward the holder body 21 side (the lower side). Namely, the pressing section 265 presses the optical path conversion connector 10 toward the circuit board 30 side. The position of the optical path conversion connector 10 is thereby fixed in the up-and-down direction (in the direction of the optical axis of the optical signals).

As illustrated in FIG. 3, when the lid 26 has been closed, the lower end of the pressing section 265 is above the recess 18 in the optical path conversion connector 10, and is at substantially the same position as the front-to-rear direction position of the opening 22C of the holder body 21. The pressing section 265 is positioned between the two positioning holes 22B when the lid 26 has been closed. Thus, the pressing section 265 presses a site located between the two positioning pins 16, which are formed on the optical path conversion connector 10, toward the holder body 21 side (the lower side). The optical path conversion connector 10 is thereby rendered less liable to come out from the holder body 21.

The pressing section 265 is configured such that, when the lid 26 has been closed, the pressing section covers the reflection surface 14 of the optical path conversion connector 10. This thereby enables contamination of the reflection surface 14 by dirt, dust, and the like to be suppressed, and enables the optical properties of the reflection surface 14 to be maintained. It should be noted that positionally aligning the connector holder 20 and the optical path conversion connector 10 using the positioning pins 16 and the positioning holes 22B enables the pressing section 265 to reliably cover the reflection surface 14 of the optical path conversion connector 10.

When the lid 26 has been closed, the pressing section 265 presses the two edges of the optical path conversion connector 10 that are located on the respective outer sides of the recess 18 in the left-to-right direction.

The operation section 266 is a part for performing opening and closing operations of the lid 26. The operation section 266 is disposed at the rear side of the lid body section 261 (on the opposite side from the shaft bearings 262).

{Attachment and Detachment of Optical Path Conversion Connector 10}

FIG. 4A to FIG. 4C are views from above of the connector holder 20. FIG. 4A is a diagram of the connector holder 20 alone, FIG. 4B is a diagram of a state in which the optical path conversion connector 10 is housed in the connector housing part 24 of the connector holder 20, and FIG. 4C is a diagram of a state in which the lid 26 of the connector holder 20 has been closed.

In order to attach the optical path conversion connector 10 to the connector holder 20, first the operation section 266 is lifted up, and the lid 26 of the connector holder 20 is opened (FIG. 4A). It should be noted that the connector holder 20 is fixed to the circuit board 30 on which the photoelectric conversion module (not illustrated) is mounted.

The optical path conversion connector 10 is then housed in the connector housing part 24 of the holder body 21 of the connector holder 20 (FIG. 4B). When this is performed, positioning is performed in the front-to-rear direction by inserting (fitting) the positioning pins 16 of the optical path conversion connector 10 into the respective positioning holes 22B of the connector holder 20. Namely, the optical signal surface 13 of the optical path conversion connector is positioned so as to oppose the opening 222 in the connector holder 20 (and the photoelectric conversion element of the circuit board 30).

Also, positioning is performed in the left-to-right direction (the width direction) by housing the optical path conversion connector 10 between the respective inner wall surfaces of the pair of side wall parts 231.

Because a wider-width recess 231B is provided on the inner side of each of the side wall parts 23A of the connector holder 20, a gap is formed between a side surface of the optical path conversion connector 10 and each wider-width recess 231B. Thus, when a tool 40 (for example tweezers) is employed to house the optical path conversion connector 10 inside the connector housing part 24 of the holder body 21, the tool 40 is not hindered (see FIG. 2A). Thus, also in such cases, the optical path conversion connector 10 can be arranged (housed) in the connector housing part 24 easily.

The lid 26 of the connector holder 20 is then closed (FIG. 4C). When this is performed, the engagement sections 263 of the lid 26 engage with the respective anchor sections 231A of the holder body 21. As a result, the pressing section 265 of the lid 26 presses the two edges of the optical path conversion connector 10 that are located on the respective outer sides of the recess 18 in the left-to-right direction, while elastically deforming. The optical path conversion connector 10 is pressed toward the base body part 22 of the connector holder 20 by the pressing section 265 and is accordingly positioned also in the up-and-down direction. This thereby enables the optical path conversion connector 10 to be reliably fixed to the connector holder 20. Moreover, the optical path conversion connector 10 can be maintained in a state sandwiched between the base body part 22 and the lid 26, due to the engagement sections 263 of the lid 26 engaging with the respective anchor sections 231A of the holder body 21.

The above procedure is performed in reverse when removing the optical path conversion connector 10 from the connector holder 20.

More specifically, the operation section 266 of the lid 26 is lifted up from the state of FIG. 4C, to release the engaged state between the engagement sections 263 of the lid 26 and the anchor sections 231A of the holder body 21. The lid 26 of the connector holder 20 is thereby opened.

Then, a tool 40 (for example tweezers) or the like is employed to remove the optical path conversion connector 10 from the connector housing part 24 of the holder body 21. When this is performed in the present embodiment, due to the gaps being formed between the side surfaces of the optical path conversion connector 10 and the respective wider-width recesses 231B, as described above, the tool is easily inserted into these gaps. Thus, the optical path conversion connector 10 can be removed easily.

As explained above, the connector holder 20 of the present embodiment includes: a base body part 22; a pair of side wall parts 231 that projects from the base body part 22; and a connector housing part 24 that is formed by the base body part 22 and the pair of side wall parts 231, and that is for housing an optical path conversion connector 10 which holds an end section of an optical fiber tape 3 (optical fibers 3A). A wider-width recess 231B is formed in the inner surface of each of the side wall parts 231, the recesses being formed so as to oppose one another, and a gap is formed between a side surface of the optical path conversion connector 10 and each wider-width recess 231B when the optical path conversion connector 10 is housed in the connector housing part 24.

Thus, the connector holder 20 of the first embodiment facilitates insertion of the tool 40 or the like into the gaps between the side surfaces of the optical path conversion connector 10 and the respective wider-width recesses 231B, thereby enabling easy removal of the optical path conversion connector 10.

### Second Embodiment

In the second embodiment, the shape of the wider-width recesses formed in the respective side wall parts 231 is different from that of the first embodiment. It should be noted that features in the second embodiment that are the same as those of the first embodiment are appended with the same reference signs, and explanation thereof is omitted.

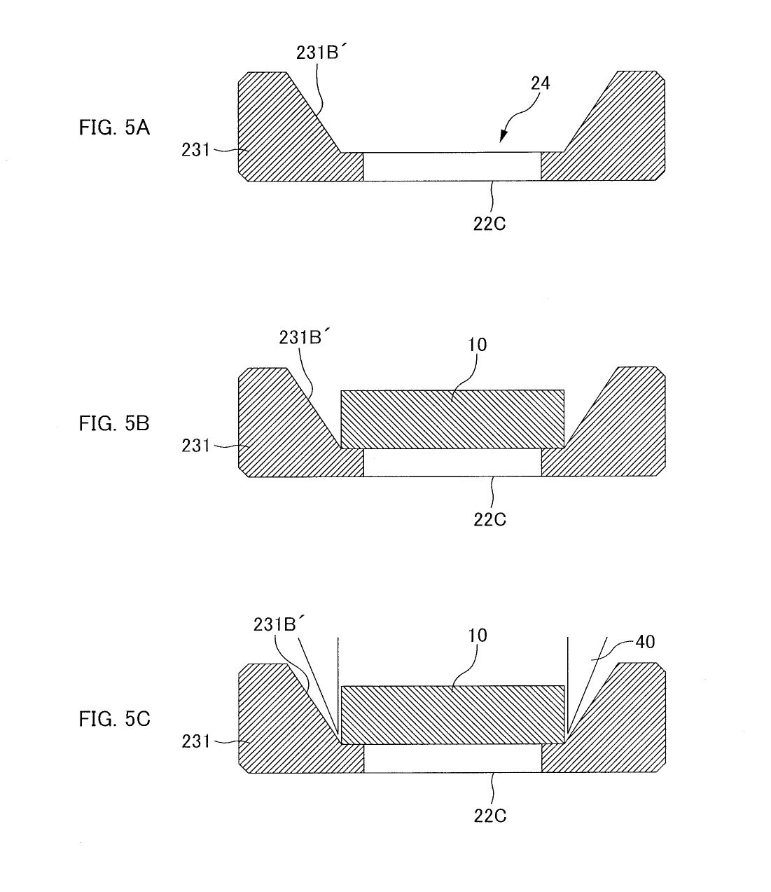

FIG. 5A to FIG. 5C are explanatory diagrams of a connector holder 20 of the second embodiment. FIG. 5A is a cross-section when a connector housing part 24 is empty, FIG. 5B is a cross-section when an optical path conversion connector 10 is housed in the connector housing part 24, and FIG. 5C is a cross-section when a tool 40 has been inserted. It should be noted that FIG. 5A to FIG. 5C are cross-sections perpendicular to the front-to-rear direction.

In the second embodiment, a wider-width recess 231B′ is provided to the inner side of each side wall part 231. Each wider-width recess 231B′ of the second embodiment has a tapered surface such that the length (thickness) in the left-to-right direction of each side wall part 231 increases toward the lower side. In other words, the left-to-right direction distance of the connector housing part 24 decreases toward the lower side. This thereby enables the optical path conversion connector 10 to be guided along the tapered surfaces when the optical path conversion connector 10 is being housed in the connector housing part 24, and thus, positional misalignment of the optical path conversion connector 10 can be suppressed. A tapered gap is formed between a side surface of the optical path conversion connector 10 and each wider-width recess 231B′. Thus, the leading ends of a tool 40 (e.g. tweezers) are easily inserted into the respective gaps when removing the optical path conversion connector using the tool 40 as in FIG. 5C, enabling the leading ends of the tool 40 to be guided along the tapered surfaces to a position at a lower portion of the optical path conversion connector 10. This thereby enables the optical path conversion connector 10 to be easily removed also in the second embodiment.

Others:

The foregoing embodiments are for facilitating the understanding of the present invention, and are not to be construed as to limit the present invention. Needless to say, the present invention may be modified and/or improved without departing from the gist thereof, and the present invention encompasses equivalents thereof.

{Disposition of Connector Holder 20}

In the foregoing embodiments, the photoelectric conversion module is mounted to the lower surface of the circuit board 30, and the connector holder 20 is disposed so as to oppose the photoelectric conversion module across the circuit board 30; however, there is no limitation thereto. For example, the photoelectric conversion module may be provided on the upper surface of the circuit board 30, and the connector holder 20 may be fixed thereon.

{Engagement of Holder Body 21 and Lid 26}

The number of pairings (engagement locations) between the anchor sections 231A and the engagement sections 263 is not limited to two, and it is sufficient that there is at least one.

### REFERENCE SIGNS LIST

1: Optical connector device;
3: Optical fiber tape; 3A: Optical fibers;
10: Optical path conversion connector;
11: Optical fiber insertion opening;
12: Optical fiber holes;
13: Optical signal surface;
14: Reflection surface;
16: Positioning pins;
17A: First adhesive-filled section;
17B: Second adhesive-filled section;
18: Recess;
20: Connector holder (receptacle); 21: Holder body;
22: Base body part; 22B: Positioning holes; 22C: Opening;
23: Wall part; 231: Side wall parts;
231A: Anchor sections; 231B: Wider-width recesses;
232: Front wall part; 25: Rotation shaft;
26: Lid; 261: Lid body section; 262: Shaft bearings;
263: Engagement sections; 265: Pressing section;
266: Operation section;
30: Circuit board;
40: Tool.

What is claimed is:

1. A connector holder comprising
a base body part,
a pair of side wall parts that projects from said base body part, and
a connector housing part that is formed by said base body part and said pair of side wall parts, and that is for housing an optical connector body which holds an end section of an optical fiber, wherein:
a recess is formed in an inner surface of each of said side wall parts, said recesses being formed so as to oppose one another; and
a gap is formed between a side surface of said optical connector body and each said recess when said optical connector body is housed in said connector housing part.

2. The connector holder according to claim 1, wherein a tapered surface is formed to each said recess.

3. The connector holder according to claim 1, wherein:
said connector holder further comprises a lid that sandwiches, between itself and said base body part, said optical connector body housed in said connector housing part; and
said lid includes a pressing section that presses said optical connector body toward said base body part.

4. The connector holder according to claim 3, wherein said lid includes an engagement section that engages with a body-side engagement section provided to each of said side wall parts.
